(19) United States
(12) Patent Application Publication
(10) Pub. No.: US 2025/0156772 A1
(43) Pub. Date: May 15, 2025

(54) NETWORK OPERATION EXECUTION USING HYBRID MACHINE LEARNING

(71) Applicant: ADP, Inc., Roseland, NJ (US)

(72) Inventors: Sanjay Varma Rudraraju, Florham Park, NJ (US); Naga Venkata Lakshmi Ramyasree Suddapalli, Hyderabad (IN); Brian Marshall, Florham Park, NJ (US); Divya Srivastava, Florham Park, NJ (US); Ankush Chauhan, Florham Park, NJ (US); Steve Little, Florham Park, NJ (US)

(73) Assignee: ADP, Inc., Roseland, NJ (US)

(21) Appl. No.: 18/947,937

(22) Filed: Nov. 14, 2024

Related U.S. Application Data
(60) Provisional application No. 63/599,434, filed on Nov. 15, 2023.

(51) Int. Cl. G06N 20/20; G06Q 40/12

(52) U.S. Cl. CPC G06N 20/20; G06Q 40/125

(57) ABSTRACT

A system can identify data points associated with a profile data structure for a first time interval. The system can detect, from a data source, events indicative of modifying the data points associated with the profile data structure for a second time interval. The system can update, based on the events, one or more machine learning models of a hybrid machine learning model. The system can generate a predicted data point associated with the profile data structure based on the data points and the events being input into the hybrid machine learning model. The system can determine a variance in response to comparing the predicted data point for the second time interval to the data points identified for the first time interval. The system can transmit the variance to a payroll processing system to execute, for the second time interval, a network operation associated with the profile data structure.

### CROSS-REFERENCE TO RELATED APPLICATIONS

This application claims the benefit of and priority to U.S. Provisional Application No. 63/599,434, filed Nov. 15, 2023, the entirety of which is incorporated by reference herein.

### TECHNICAL FIELD

This application is generally related to computing technology and, more particularly, to network operation execution based on event detection and predictive analytics using a hybrid machine learning model.

### BACKGROUND

Various systems perform network operations using configuration information, with one or more systems executing some or all portions of network operations based on these configurations. As systems grow in complexity with multiple components and dependencies, efficiently and reliably executing network operations becomes challenging. This complexity introduces risks of errors, delays, or inefficiencies, particularly when adapting to changing conditions or unexpected events.

### SUMMARY

Aspects of the technical solutions described herein are directed to a computing architecture that addresses challenges related to scalability, latency, dynamic adaptability, and efficient execution in cross-system operations. For example, batch processing models can introduce latency, which limits the timely execution of compliance checks and updates. Slow data storage and processing throughput restrict real-time or near real-time processing of large data volumes, impacting the accuracy and timeliness of compliance evaluations. Additionally, a lack of robust real-time data integration and feature engineering capabilities limits the predictive accuracy of compliance models. Many systems lack response capabilities to detected events. For example, data storage and processing systems often adapt slowly to external regulatory changes, with manual intervention desired for frequent feature engineering and model updates, thereby consuming substantial computational resources. Consequently, in a complex network operation computing environment, such as multi-country contribution services, it can be challenging to scale network operations reliably and efficiently.

The technical solutions described herein address such technical challenges by implementing a computing architecture configured to improve scalability, reduce latency, and provide dynamic adaptability and efficient execution across system operations, particularly in compliance-critical environments. The computing architecture implements distributed edge computing for data preprocessing, which processes data locally before transmission to the central system, thereby minimizing data transmission latency and bandwidth usage. By reducing the network load, distributed edge computing provides faster data availability for processing. The computing architecture incorporates adaptive real-time or near real-time machine learning models, utilizing online learning algorithms, such as gradient descent and incremental support vector machines (SVM), to update model parameters as new data streams are detected, facilitating predictive analytics that utilizes historical data to make predictions about future contribution trends. This configuration allows models to adapt immediately to new data and provide timely and accurate compliance forecasts. Additionally, the technical solutions implement a hybrid neural network architecture, which combines long short-term memory (LSTM) units, temporal convolutional networks (TCN), and attention mechanisms, among others, to detect long-term dependencies and short-term patterns, thereby enhancing predictive accuracy for real-time compliance evaluation.

Moreover, the technical solutions described herein integrate high-frequency external data sources, such as macroeconomic and microeconomic indicators, through APIs and data feeds, allowing the system to dynamically adjust forecasts based on one or more conditions (e.g., economic conditions, geopolitical conditions, weather conditions, personal conditions, etc.), or changes to such conditions. This integration enhances the model's responsiveness and precision by incorporating immediate external influences. The computing architecture utilizes complex event processing (CEP) engines to detect patterns and correlations in event streams, such as natural disasters or policy changes that may impact compliance behaviors. This event-driven processing allows the system to respond swiftly to events and automatically triggers model adjustments.

Furthermore, the technical solutions described herein utilize columnar databases and in-memory data grids that improve data retrieval and processing speed. The optimized storage reduces latency and supports large-scale data analytics with efficient storage management. The computing architecture implements feature engineering to automatically generate higher-order features, reducing the time and resources spent on manual feature creation and facilitating the detection of complex patterns that enhance predictive performance. The computing architecture leverages parallel processing frameworks to reduce computation time for model training and inference on large datasets. This parallelized, hardware-accelerated approach improves resource utilization. As a result, the technical solutions described herein facilitate the computing architecture in satisfying the demands of scalable, real-time, and automated compliance evaluation in complex operational environments, thereby providing robust and efficient performance across diverse systems.

As described herein, the technical solutions herein are rooted in computing technology and provide improvements to one or more aspects of computing technology, such as hybrid neural network architectures and their use. Further, the technical solutions herein facilitate improvements to payroll processing systems by facilitating dynamic updates to the processing being performed by such payroll processing systems. The technical solutions described herein facilitate improvements to the hybrid neural network architectures by facilitating dynamic updates to one or more component models of the hybrid neural network architecture. The dynamic updates are based on predicted data generated by the hybrid machine neural network in some aspects. The technical solutions described herein provide a practical application by facilitating systems, such as a payroll processing system, to use such a hybrid neural network architecture that is updated at runtime. In some aspects, the technical solutions described herein provide improved payroll processing systems that perform actions/adjustments based on dynamically updated (at runtime) hybrid neural network models.

An aspect of the technical solutions described herein is directed to a system. The system includes one or more processors coupled with memory. The system can identify, from a database, data points associated with a profile data structure for a first time interval. The system can detect, from a data source, one or more events indicative of modifying the data points associated with the profile data structure for a second time interval. The system can update, based on the one or more events, one or more machine learning models of a hybrid machine learning model that comprises a plurality of machine learning models, the update comprising an adjustment of at least one of the plurality of machine learning models. The system can generate a predicted data point associated with the profile data structure for the second time interval based on the data points and the one or more events being input into the hybrid machine learning model. The system can determine a variance in response to comparing the predicted data point for the second time interval to the data points identified for the first time interval. The system can transmit the variance to a payroll processing system to cause the payroll processing system to execute, for the second time interval, a network operation associated with the profile data structure based on the variance.

The system can detect the one or more events from the data source based on patterns indicative of causing changes to the data points associated with the profile data structure. The system can extract the one or more events as input data for the hybrid machine learning model. The hybrid machine learning model can include at least one of a long short-term memory network, a temporal convolutional network, an attention layer, a random forest, or a gradient boosting machine. The system can update the at least one of the plurality of machine learning models of the hybrid machine learning model based on a relevance of the at least one of the plurality of machine learning models to the one or more events. The system can update weights of the at least one of the plurality of machine learning models of the hybrid machine learning model based on the one or more events. The system can adjust hyperparameters of the at least one of the plurality of machine learning models based on the one or more events. The system can select, based on the one or more events, the at least one of the plurality of machine learning models of the hybrid machine learning model to receive input data, including the data points and the one or more events. The system can aggregate predicted data points of each selected machine learning model to generate the predicted data point for the second time interval. The system can cause the payroll processing system to execute the network operation in response to determining that the variance satisfies a threshold. The system can cause the payroll processing system to block the network operation in response to determining that the variance exceeds a threshold. The system can train the at least one of the plurality of machine learning models based on a training dataset, including a plurality of events and corresponding data points. The hybrid machine learning model can generate the predicted data point based on determining long-term dependencies and local temporal patterns in the data points and the one or more events associated with the profile data structure for the second time interval.

An aspect of the technical solutions described herein is directed to a method. The method can include identifying, from a database, data points associated with a profile data structure for a first time interval. The method can include detecting, from a data source, one or more events indicative of modifying the data points associated with the profile data structure for a second time interval. The method can include reconfiguring, based on the one or more events, one or more machine learning models of a hybrid machine learning model. The method can include generating a predicted data point associated with the profile data structure for the second time interval using the data points and the one or more events as input into the hybrid machine learning model that is reconfigured. The method can include determining a variance in response to comparing the predicted data point for the second time interval to the data points identified for the first time interval. The method can include causing a payroll processing system to execute one or more computer instructions by transmitting the variance to the payroll processing system, the payroll processing system using the variance to execute the one or more computer instructions.

The method can include detecting the one or more events from the data source based on patterns indicative of causing changes to the data points associated with the profile data structure. The method can include extracting the one or more events for input into the hybrid machine learning model. The hybrid machine learning model can include at least one of a long short-term memory network, a temporal convolutional network, an attention layer, a random forest, or a gradient boosting machine. The method can include reconfiguring the one or more machine learning models of the hybrid machine learning model based on a relevance of the one or more machine learning models to the one or more events. The method can include reconfiguring weights of the one or more machine learning models of the hybrid machine learning model based on the one or more events. The method can include adjusting hyperparameters of the one or more machine learning models based on the one or more events. The method can include selecting, based on the one or more events, the one or more machine learning models of the hybrid machine learning model to receive input data comprising the data points and the one or more events. The method can include aggregating predicted data points of each selected machine learning model to generate the predicted data point for the second time interval. The method can include causing the payroll processing system to execute the one or more computer instructions in response to determining that the variance satisfies a threshold.

An aspect of this disclosure can be directed to a non-transitory computer readable medium, including one or more instructions stored thereon and executable by a processor. The processor can identify, from a database, data points associated with a profile data structure for a first time interval. The processor can detect, from a data source, one or more events indicative of modifying the data points associated with the profile data structure for a second time interval. The processor can adjust, based on the one or more events, a hybrid machine learning model by adjusting parameters of one or more machine learning models of the hybrid machine learning model. The processor can generate, using the hybrid machine learning model that is adjusted, a predicted data point associated with the profile data structure for the second time interval. The processor can determine a variance between the predicted data point for the second time interval and the data points identified for the first time interval. The processor can present, via a graphical user interface, the data points, the one or more events, and the variance.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with some implementations.

FIG. 2 depicts an example method of network operation execution based on event detection and predictive analytics using a hybrid machine learning model, in accordance with some implementations.

FIG. 3 depicts an example line chart illustrating model performance over time, in accordance with some implementations.

FIG. 4 depicts an example bar chart illustrating the impact of events on predictions, in accordance with some implementations.

FIG. 5 depicts an example horizontal bar chart illustrating feature importance, in accordance with some implementations.

FIG. 6 depicts an example pie chart illustrating a risk level distribution, in accordance with some implementations.

FIG. 7 depicts a block diagram of an example computing system for implementing the embodiments of the present solution, including, for example, the system depicted in FIG. 1, and the method depicted in FIG. 2.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation. Several other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein implement network operation execution based on event detection and predictive analytics using a hybrid machine learning model. The system identifies data points from a database associated with a profile data structure for a designated first time interval. Additionally, the system detects events from a data source that can impact the data points associated with the profile data structure for a subsequent time interval. Upon detecting the events, the system updates one or more machine learning models of a hybrid machine learning framework based on the events. The system can select one or more machine learning models of the hybrid machine learning model based on the events. The identified data points and detected events are inputted into the hybrid machine learning model, which generates a predicted data point associated with the profile data structure for the second time interval. The system determines a variance by comparing the predicted data point to the data points initially identified for the first time interval. The system transmits the variance to a payroll processing system, causing the payroll processing system to execute a network operation based on the identified variance. The computing architecture, thus, enhances operational efficiency, responsiveness, and accuracy in network operations by dynamically adapting to event-driven data variations.

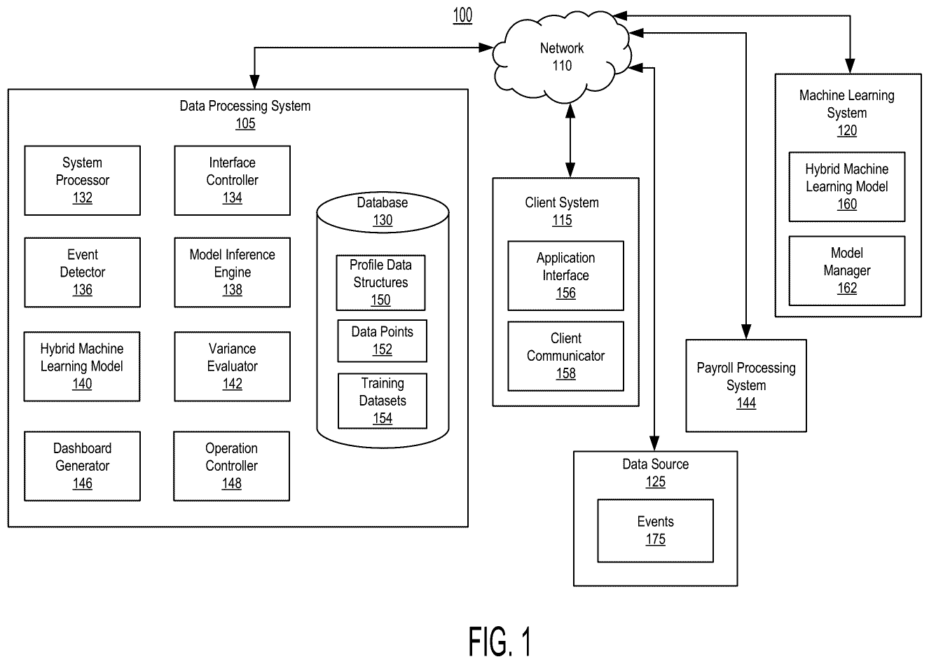

FIG. 1 depicts an example system according to one or more aspects of the technical solutions described herein. As illustrated by way of example in FIG. 1, a system 100 can include one or more of a data processing system 105, a client system 115, a machine learning system 120, a data source 125, and a payroll processing system 144. One or more components of the system 100 can communicate via network 110.

The data processing system 105 can include a physical computer system operatively coupled or couplable with one or more components of the system 100. The data processing system 105 can include, host, or be hosted by or on a cloud system, a server, a distributed remote system, or any combination thereof. The data processing system 105 can include a virtual computing system, an operating system, and a communication bus to effect communication and processing. The data processing system 105 can include physical infrastructure, such as physical servers, storage devices, and network equipment housed in data centers. The data processing system 105 can include a virtual computing system, which can include cloud-based virtual machines or containers for running applications and services. The data processing system 105 can include an operating system that can function as the core manager, allocating resources, configuring processes, and maintaining seamless interaction between hardware and applications. The data processing system 105 can include a communication bus that can facilitate communication between different components within the system. The data processing system 105 can be configured to connect with external systems to allow for data exchange and service delivery to end users.

The network 110 can include any type or form of network. The geographical scope of the network 110 can vary widely and the network 110 can include a body area network (BAN), a personal area network (PAN), a local-area network (LAN), e.g., Intranet, a metropolitan area network (MAN), a wide area network (WAN), or the Internet. The topology of the network 110 can be of any form and can include, e.g., any of the following: point-to-point, bus, star, ring, mesh, or tree. The network 110 can include an overlay network which is virtual and sits on top of one or more layers of other networks 110. The network 110 can be of any such network topology as known to those ordinarily skilled in the art capable of supporting the operations described herein. For example, the network 110 can be any form of computer network that can relay information between the data processing system 105, the client system 115, the machine learning system 120, the data source 125, and the payroll processing system 144. The network 110 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 110 can include a type of a broadcast network, a telecommunications network, a data communication network, or a computer network.

The client system 115 (also referred to herein as the client device) can include a computing system that can be used to access the functionality of the data processing system 105. The client system 115 can include a smart phone, mobile device, laptop computer, desktop computer, one or more servers, or any other type of computing device. The client system 115 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 115 can include one or more devices to receive input from a user or to provide output to a user. For example, the output capabilities of the client system 115 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

Each client device 115 can be associated with an identifier used to identify devices or user profiles operating the client devices 115. The identifier can be of one or more forms, such as a device ID, which can be a code assigned to the client device 115 by the manufacturer or operating system, a MAC address, which can be a hardware address assigned to the client device's network interface, or an IP address, which can identify the client device 115 on a network. The identifier can be a user ID associated with the user profile operating the client device 115, or a session ID, which can be a temporary identifier assigned to a specific session. Other identifiers, such as a serial number, can be used depending on the system and device configuration.

The client system 115 can execute an application that communicates with the data processing system 105. The application can present one or more application interfaces 156. The application interface 156 can include a set of rules or protocols that allow different software programs or systems to communicate with each other. The application interface 156 can provide user interfaces to facilitate interaction. Users can input information, view content, or initiate actions through the application interface 156. The client application can include an application executing on each client system 115. The client application can include a web application, a server application, a resource, a desktop, or a file. In some embodiments, the client application can include a local application (e.g., local to a client system 115), a hosted application, a software-as-a-service (SaaS) application, a virtual application, a mobile application, and other forms of content. In some embodiments, the client application can include or correspond to applications provided by remote servers or third-party servers.

The client system 115 can include, interface with, communicate with, or otherwise utilize a client communicator 158. The client communicator 158 within the client system 115 can be similar to, and include any of the structure and functionality of, the interface controller 134 described in connection with the data processing system 105. For example, the client communicator 158 within the client system 115 can communicate with the data processing system 105, the machine learning system 120, the data source 125, or the payroll processing system 144 via the network 110 using one or more communication interfaces to carry out the various operations described herein. The client communicator 158 can be compatible with particular content delivery systems corresponding to particular content objects, structures of data, types of data, or any combination thereof.

The system 100 is shown as including the data source 125, which can be accessible via the network 110. The data source 125 can be a computing system, server, data repository, or any other source of data that can store, provide, or otherwise maintain any of the information relating to events 175. The data source 125 can include hardware, software, or any combination thereof. In some implementations, the data source 125 can include one or more components to facilitate data collection, processing, storage, and delivery, among others. For example, the data source 125 can include APIs and web scrapers to collect data from various sources, such as financial information repositories, macroeconomic and microeconomic indicator databases, or regulatory data feeds, among others. The data source 125 can implement a distributed computing framework where data preprocessing can occur at the source (e.g., client servers, data entry points) using edge computing technologies, including edge processing nodes or local servers to preprocess data (e.g., data normalization, encoding) before transmission. In some embodiments, the data source 125 can be or include one or more computing systems of third-party data providers, such as financial analytics services, environmental monitoring systems, or economic data aggregation platforms, among others.

The data source 125 can provide real-time or near real-time data feeds that provide live updates on financial, regulatory, or environmental metrics associated with events 175. The data source 125 can provide a continuous data pipeline that can be used to feed real-time updates on financial, regulatory, or environmental metrics associated with events 175 into the hybrid machine learning model 160. The events 175 can include a wide range of factors, including regulatory changes, economic conditions, or societal trends, that can impact regulatory compliance requirements, such as retirement contribution requirements. The regulatory compliance requirements can be of one or more jurisdictions (countries, states, counties, cities, unions, etc.). The events 175 can correspond to financial fluctuations, such as market volatility, interest rate changes, inflation rates, or economic recessions. In some embodiments, the events 175 can correspond to regulatory events, such as changes in tax laws, pension reforms, fiduciary regulations, or social security adjustments. In some embodiments, the events 175 can correspond to environmental factors, such as climate change policies, natural disasters, sustainability initiatives, and ESG (environmental, social, and governance) criteria. In some embodiments, the events 175 can correspond to geopolitical events, such as wars, trade disputes, or political instability.

The data processing system 105 can include, interface with, communicate with, or otherwise utilize a database 130. The database 130 can be a computer-readable memory that can store or maintain any of the information described herein. The database 130 can store data associated with the system 100. The database 130 can include one or more hardware memory devices to store binary data, digital data, or the like. The database 130 can include one or more electrical components, electronic components, programmable electronic components, reprogrammable electronic components, integrated circuits, semiconductor devices, flip flops, arithmetic units, or the like. The database 130 can include at least one of a non-volatile memory device, a solid-state memory device, a flash memory device, or a NAND memory device. The database 130 can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the database 130 can correspond to a non-transitory computer readable medium. In an aspect, the non-transitory computer readable medium can include one or more instructions executable by a system processor 132.

The database 130 can store or maintain one or more data structures, which can include containers, indices, or otherwise store each of the values, pluralities, sets, variables, vectors, numbers, or thresholds described herein. The database 130 can utilize columnar storage databases or in-memory data grids for high-speed data access and processing. The database 130 can be accessed using one or more memory addresses, index values, or identifiers of any item, structure, or region maintained in the database 130. The database 130 can be accessed by the components of the data processing system 105, the client system 115, the machine learning system 120, or any other computing device described herein, via the network 110. The database 130 can be internal to the data processing system 105. The database 130 can exist external to the data processing system 105 and can be accessed via the network 110. For example, the database 130 can be distributed across many different computer systems (e.g., a cloud computing system) or storage elements and can be accessed via the network 110 or a suitable computer bus interface.

The database 130 can store or maintain one or more profile data structure 150. The profile data structure 150 can include a structured representation of an entity. The profile data structure 150 can include relevant details for regulatory compliance or contribution management. For example, the profile data structure 150 associated with a user profile can include personal details (name, address), employment information (job title, hire date, department), compensation data (salary, bonuses, contribution values), or tax details (withholdings, filing status), among other regulatory attributes. The profile data structure 150 can include attributes with specific data types (e.g., name: string, salary: decimal). Each attribute can have a specific data type, such as a string, integer, date, or Boolean. The profile data structure 150 can organize entities in a hierarchical structure, where one entity acts as a parent to multiple child entities (e.g., a company profile having a hierarchical relationship with department profiles, and department profiles having hierarchical relationships with employee profiles). The profile data structure 150 can include metadata such as creation date, modification timestamps, data source, and ownership, among others. The metadata attributes can facilitate management of regulatory compliance, contribution tracking, and updates, such that the profile data remains current and compliant with evolving requirements.

Each profile data structure 150 can be associated with data points 152. The data points 152 can be stored or maintained in the database 130. The data points 152 can correspond to or include relevant details that contribute to the overall profile of an entity. In the context of retirement planning, the data points 152 can be numerical, categorical, or temporal, capturing details about individual users, employees, employers, or plan sponsors. For example, an individual user profile can include numerical data points such as salary, bonuses, 401(k) contribution percentage, investment returns, or age. The categorical data points can include gender, marital status, job title, department, or risk tolerance level. The temporal data points can include date of birth, hire date, retirement date, contribution history, or historical economic indicators, such as past inflation rates or market trend. An employer profile can include numerical data points 152 such as the number of employees, annual revenue, profit margin, and 401(k) plan match rate. In this regard, the categorical data points 152 can include industry, company size, or retirement plan type, and the temporal data points 152 can include the company founding date or recent performance trends. A plan sponsor profile can include numerical data points 152 such as plan assets, liabilities, expense ratio, or fee structure. In this regard, the categorical data points 152 can include plan type, investment options, or service provider, and the temporal data points 152 can include the plan inception date, recent performance trends, or relevant historical economic indicators.

The data points 152 can be associated with the profile data structures 150 through relationships or key constraints in the database. For example, a user's salary data point can be associated with their user profile data structure 150, and a company's revenue data point 152 can be associated with the company's profile data structure 150. In a relational database, the data points 152 can be stored in separate tables and associated with the profile data structure table using primary or foreign key relationships. For example, a user table can include user information, and a salary table can include salary information for each user, with a key relationship associating the two tables. In a NoSQL database, the data points 152 can be embedded within the profile data structure 150 or stored in separate collections and linked through document IDs or other reference mechanisms. For example, in a JSON document corresponding to a user profile, the salary data point 152 can be embedded within the document itself, or the data point 152 can be stored in a separate collection and referenced by an identifier.

The database 130 can store or maintain a training dataset 154 used to train the one or more hybrid machine learning models 160. The training dataset 154 can include regulatory requirements, industry standards, legislative directives, and additional factors such as market conditions, environmental indicators, geopolitical events, and macroeconomic or microeconomic trends to support compliance-related model training, such as retirement contribution compliance training. The training dataset 154 can undergo preprocessing, such as cleaning, normalization, and tokenization, to prepare the data for learning. For supervised learning, the training dataset 154 can be labeled according to various retirement compliance categories to guide the hybrid machine learning model 160 in identifying relevant compliance topics. These categories can include contribution limits, eligibility requirements, tax implications, investment restrictions, withdrawal conditions, employer matching policies, reporting and disclosure obligations, market stability and risk management, geopolitical and economic sensitivities, or ESG factors, among others. For unsupervised learning, the training dataset 154 can provide unlabeled data, allowing the hybrid machine learning models 160 to detect patterns or clusters related to retirement compliance without predefined categories.

The training dataset 154 can be formatted in standard formats such as CSV, JSON, or custom formats to facilitate compatibility with the hybrid machine learning model 160. The training dataset 154 can include curated examples annotated with retirement-specific compliance categories, functioning as benchmarks for training or evaluating the hybrid machine learning models 160 on compliance-based data points, such as contribution limits. The sequence length in the training dataset 154 can be limited to a threshold to optimize the hybrid machine learning model's performance. The training dataset 154 can include a filtered version of applicable compliance categories and be divided into training, test, and validation sets to facilitate thorough model evaluation.

The training dataset 154 can associate events 175 with corresponding data points 152 to allow the hybrid machine learning model 160 to identify patterns and impacts related to retirement contributions. For example, the association in the training dataset 154 can allow the hybrid machine learning model 160 to identify trends between events and contribution behavior, such as a market downturn correlating with reduced average contribution values. The training dataset 154 can associate events 175 with corresponding data points 152 through techniques such as temporal alignment (e.g., which associates events with specific historical periods), event labeling (e.g., which assigns labels to data points based on the type and severity of the event), or feature engineering to generate event-based features, such as indicators or metrics, that quantify the influence of events on data points and enhance the model's predictive accuracy for future contributions.

The training dataset 154 can associate events 175 with one or more machine learning models of the hybrid machine learning model 160, based on the specific characteristics of the events or the desired prediction outcomes. For example, time-series events, such as economic cycles or market trends, can be associated with models such as long short-term memory (LSTM) networks or temporal convolutional networks (TCNs), which can be optimized for sequential data. Categorical events, such as regulatory changes, policy shifts, or demographic shifts, can be associated with models such as random forests or gradient boosting machines, which can be effective for processing structured data. Textual events, such as news articles or social media sentiment, can be associated with natural language processing (NLP) techniques and models such as recurrent neural networks (RNNs) or transformers, which can be used for processing language data.

The training dataset 154 can include examples of events 175 and their associated data points 152. Each event 175 within the training dataset 154 can correspond to a set of conditions impacting retirement contributions, such as economic factors, regulatory changes, market trends, geopolitical events, or environmental conditions. The events 175 can correspond to compliance thresholds or other relevant influences across regulatory, legislative, industry, geopolitical, or environmental standards, affecting retirement contribution values. The events 175 can include various compliance and impact factors, such as regulatory requirements (e.g., laws, legislative directives, or industry standards), market fluctuations (e.g., stock performance, interest rates), geopolitical shifts (e.g., trade disputes, conflicts), or environmental conditions (e.g., climate policies, natural disasters). The training dataset 154 can include instances of events 175 and their associated data points 152, along with metadata to facilitate identifying how events impact contribution patterns. For example, metadata can provide contextual information, such as event descriptions, historical trends, or timestamped records of data points, allowing the hybrid machine learning model 160 to evaluate changes in contribution behaviors over time. The hybrid machine learning model 160 can utilize the examples to learn how to detect shifts in contribution behaviors based on event-driven changes in metadata or other contextual indicators. For example, the training dataset 154 can include historical data reflecting regulatory changes, market trends, geopolitical events, or environmental factors, with each dataset illustrating how associated data points evolve over time. By evaluating these examples, the hybrid machine learning model 160 can identify patterns, such as the emergence of new compliance thresholds or shifts in economic and geopolitical factors, and apply this knowledge to predict or forecast variations in subsequent datasets.

The data processing system 105 can include, interface with, communicate with, or otherwise utilize a system processor 132. The system processor 132 can be or include any script, file, program, application, set of instructions, or computer-executable code that can be configured to execute one or more instructions associated with the data processing system 105. The system processor 132 can include an electronic processor, an integrated circuit, or the like, including one or more of digital logic, analog logic, digital sensors, analog sensors, communication buses, volatile memory, nonvolatile memory, and the like. The system processor 132 can include, but is not limited to, at least one microcontroller unit (MCU), microprocessor unit (MPU), central processing unit (CPU), graphics processing unit (GPU), physics processing unit (PPU), embedded controller (EC), or the like. The system processor 132 can include a memory operable to store one or more instructions for operating components of the system processor 132 and operating components operably coupled to the system processor 132. For example, the one or more instructions can include one or more of firmware, software, hardware, operating systems, or embedded operating systems. The system processor 132 or the data processing system 105 generally can include one or more communication bus controllers to effect communication between the system processor 132 and the other elements of the data processing system 105.

The data processing system 105 can include, interface with, communicate with, or otherwise utilize an interface controller 134. The interface controller 134 can be or include any script, file, program, application, set of instructions, or computer-executable code that can be configured to facilitate communication between the data processing system 105, the client system 115, the machine learning system 120, the data source 125, and the payroll processing system 144. The interface controller 134 can include hardware, software, or any combination. The interface controller 134 can facilitate communication between the data processing system 105, the network 110, the client system 115, the machine learning system 120, the data source 125, and the payroll processing system 144 via one or more communication interfaces. A communication interface can include, for example, an application programming interface (“API”) compatible with a particular component of the data processing system 105, the client system 115, the machine learning system 120, the data source 125, or the payroll processing system 144. The communication interface can provide a particular communication protocol compatible with a particular component of the data processing system 105, a particular component of the client system 115, a particular component of the machine learning system 120, a particular component of the data source 125, or a particular component of the payroll processing system 144. The interface controller 134 can be compatible with particular content objects and can be compatible with particular content delivery systems corresponding to particular content objects, structures of data, types of data, or any combination thereof. For example, the interface controller 134 can be compatible with the transmission of structured or unstructured data according to one or more metrics.

The data processing system 105 can include, interface with, communicate with, or otherwise utilize an event detector 136. The event detector 136 can be or include any script, file, program, application, set of instructions, or computer-executable code that can be configured to identify events 175 that can impact retirement contributions. The event detector 136 can monitor the data source 125 for new or updated information. The event detector 136 can ingest data from various sources, including real-time data feeds (e.g., news feeds) or historical data (e.g., past contribution records). In some embodiments, the ingested data can undergo preprocessing, which can include cleaning, filtering, and transforming the data for analysis. The preprocessing can include removing noise and outliers, normalizing data, extracting relevant features, or scaling features. The event detector 136 can implement various techniques to detect events 175. For example, the event detector 136 can implement keyword-based search to detect events 175 based on specific keywords or phrases, statistical anomaly detection to identify deviations from normal patterns in the data, machine learning models (e.g., classification, clustering) to learn patterns and identify events, or NLP to process textual data (e.g., news articles, social media posts) for extracting event information. The event detector 136 can perform event filtering and prioritization, where relevance filtering can exclude irrelevant events based on criteria such as event type, impact, or source reliability, and priority assignment can rank events 175 based on their potential impact on retirement contributions (e.g., prioritizing a market downturn over a minor regulatory change). The event detector 136 can generate real-time or near real-time alerts or notifications to notify users or systems of events 175 and can integrate with other systems, such as the machine learning system 120 or a payroll processing system 144, to execute appropriate actions or adjustments.

The event detector 136 can detect one or more events 175 from the data source 125 based on patterns indicative of changes to data points 152 associated with the profile data structure 150 for a subsequent time interval. The event detector 136 can utilize complex event processing (CEP) engines to detect patterns and correlations in event streams, such as natural disasters or policy changes, that can impact contribution behaviors. The event detector 136 can quantify potential impacts on specific financial behaviors or contribution patterns. Once an event 175 is detected, the event detector 136 can extract relevant details, such as the event's type, severity, or potential impact on profile data points. For example, if the event detector 136 identifies a news article about an impending economic recession, the event detector 136 can extract keywords such as recession, economic downturn, or job loss, among others. The event detector 136 can associate the identified keywords with potential impact on the user's financial condition, such as changes in income, savings rate, or investment strategy, among others.

The data processing system 105 can include, interface with, communicate with, or otherwise utilize a model inference engine 138. The model inference engine 138 can be or include any script, file, program, application, set of instructions, or computer-executable code that can be configured to prepare and provide input data to the hybrid machine learning model 160. The model inference engine 138 can identify relevant data points 152 from the database 130, such as past contribution values, income levels, or investment choices, and can select current events 175 detected by the event detector 136, such as economic indicators, regulatory changes, or geopolitical events. The model inference engine 138 can utilize information from the profile data structure 150 to determine which data points 152 are relevant to the specific context. The model inference engine 138 can evaluate historical data to identify patterns and trends. For example, to predict future retirement contributions, the model inference engine 138 can focus on data points related to income, investment returns, or retirement account balances. For event selection, the model inference engine 138 can prioritize events 175 based on factors such as event severity (e.g., economic recessions or significant policy changes), relevance to the user's financial situation (e.g., tax law changes or adjustments to benefits), or event timing, with recent events often carrying higher priority, for instance. The model inference engine 138 can evaluate the correlation between events 175 and historical data points 152 to select events 175 that can impact the target variable, such as the future contribution values or compliance risks.

The model inference engine 138 can preprocess the data or extract relevant features. The model inference engine 138 can transform the data, including the relevant data points 152 and the one or more events 175, into a suitable format, such as tensors, matrices, or data frames, for compatibility with the hybrid machine learning model 160. For example, the model inference engine 138 can transform the data into an input structure (e.g., sequence, table, or graph) and encode the data numerically for model compatibility. The model inference engine 138 can provide the prepared input data to the hybrid machine learning model 160 to cause the hybrid machine learning model 160 to generate predictions. For example, to predict a user's future retirement contributions, the model inference engine 138 can collect historical contribution data, demographic details, and recent events 175, among other factors, and integrate profile data with relevant events. The model inference engine 138 can then provide the structured input to the hybrid machine learning model 160, which generates predicted contribution values.

The model inference engine 138 can select one or more machine learning models of the hybrid machine learning model 160 based on the detected event 175. The model inference engine 138 can classify the event type, such as time-series, categorical, or textual, and select the appropriate machine learning model. For time-series events, the model inference engine 138 can select models such as LSTM networks or TCNs to evaluate temporal data patterns. For categorical events, the model inference engine 138 can select models such as random forests or gradient boosting machines to process discrete categories. For textual events, the model inference engine 138 can select NLP models, such as RNNs or transformers, for text analysis. In some embodiments, the model inference engine 138 can select the machine learning model based on model complexity, data availability, or computational resources.

The model inference engine 138 can aggregate predicted data points from each selected machine learning model of the hybrid machine learning model 160 to generate a predicted data point. Each selected machine learning model can process input data and generate its respective prediction for the target variable. The target variable can be a specific outcome the machine learning model is configured to predict, such as future retirement contribution values, income projections, or financial stability metrics. The model inference engine 138 can combine individual predictions using techniques such as simple averaging, where the model inference engine 138 can average predictions across models to generate an aggregated prediction, or weighted averaging, where the model inference engine 138 can assign weights to models based on accuracy or confidence levels. Ensemble methods, such as bagging and boosting, can enhance prediction accuracy. For example, a random forest can aggregate predictions from multiple decision trees to generate an aggregated output. In some embodiments, stacking can be applied, where a meta-model can be trained to combine the predictions from base models for improved prediction accuracy.

The data processing system 105 can include, interface with, communicate with, or otherwise utilize a variance evaluator 142. The variance evaluator 142 can be or include any script, file, program, application, set of instructions, or computer-executable code that can be configured to determine a variance between predicted and actual data points 152 associated with the profile data structure 150. The variance evaluator 142 can compare the predicted data points 152 generated by the hybrid machine learning model 160 for a specific time interval (e.g., the third quarter) with the corresponding data points 152 from a previous time interval (e.g., the first quarter). The variance evaluator 142 can align the data points 152 based on their corresponding time periods. The variance evaluator 142 can normalize the data to a common scale. The variance evaluator 142 can quantify the difference between predicted and actual data points 152 using statistical measures such as mean squared error (MSE), mean absolute error (MAE), or root mean squared error (RMSE). For example, if the predicted contribution value for a specific quarter is $5,000 and the actual value is $4,500, the variance evaluator 142 can apply the statistical measures to determine the magnitude of the difference. The variance evaluator 142 can transmit the determined variance to the payroll processing system 144. For example, the variance evaluator 142 can expose an API endpoint that the payroll processing system 144 can call to retrieve the latest variance information.

The system 100 can include, interface with, communicate with, or otherwise utilize a payroll processing system 144. The payroll processing system 144 can be or include any script, file, program, application, set of instructions, or computer-executable code that can be configured to execute a network operation, such as updating contribution records, transferring funds to retirement accounts, or generating reports on contribution activity, while maintaining end-to-end encryption for data in transit and at rest. The payroll processing system 144 can be internal to the data processing system 105. The payroll processing system 144 can exist external to the data processing system 105 and can be accessed via the network 110. The payroll processing system 144 can maintain a record of payroll-related events associated with a profile data structure 150, with role-based access controls implemented to protect sensitive or confidential information. The payroll-related events can include salary records or benefit information. The payroll-related events can be stored in the payroll records maintained by the payroll processing system 144. The payroll processing system 144 can maintain detailed audit logs for all data processing activities to maintain transparency and regulatory compliance. The payroll processing system 144 can integrate or utilize one or more of the hybrid machine learning models 160.

The payroll processing system 144 can execute a network operation or one or more computer instructions associated with the profile data structure 150 for a specific time interval. A network operation can refer to any action or operation executed by the payroll processing system 144 to modify, update, or otherwise interact with payroll-related data, such as updating payroll records, processing retirement contributions, or generating compliance reports. The one or more computer instructions can refer to a set of executable commands that cause the payroll processing system 144, the data processing system 105, the hybrid machine learning model 160, or any other computing systems to perform specific tasks related to payroll data processing, calculations, or record modifications. The data processing system 105 can transmit the variance between the predicted data points 152 and the actual or historical data points 152 to the payroll processing system 144 to cause the payroll processing system 144 to execute, for the second time interval, the network operation associated with the profile data structure 150 based on the variance. The variance can be used by the payroll processing system 144 to execute one or more computer instructions, with the payroll processing system 144 using the variance as an input parameter for executing these instructions.

The payroll processing system 144 can determine whether the variance satisfies a predefined threshold. If the variance is within acceptable limits or satisfies the predefined threshold, the payroll processing system 144 can execute the network operation, such as updating payroll records or processing retirement contributions. If the variance exceeds the threshold, the payroll processing system 144 can block the network operation. The payroll processing system 144 can cause the data processing system 105 to generate alerts for relevant operational units, such as human resources or finance departments, regarding deviations impacting payroll calculations or contribution values. In some embodiments, the payroll processing system 144 can execute automated adjustments to employee contribution rates based on the output of the hybrid machine learning model 160. For example, if the hybrid machine learning model 160 predicts an increase in the income associated with a profile data structure 150 or a decrease in their risk tolerance, the payroll processing system 144 can automatically increase the default contribution rate to the retirement plan. In another example, if the hybrid machine learning model 160 predicts a decrease in the income or an increase in risk tolerance, the payroll processing system 144 can automatically reduce the default contribution rate to the retirement plan.

The data processing system 105 can include, interface with, communicate with, or otherwise utilize a dashboard generator 146. The dashboard generator 146 can be or include any script, file, program, application, set of instructions, or computer-executable code that can be configured to present, via a graphical user interface, data points 152, events 175, and variance, or the relationship among them. The dashboard generator 146 can provide visualizations of forecasts and compliance status, generate model performance metrics over time, the impact of recent events on predictions, feature importance, or risk level distribution. The data visualization functionalities can include time series charts to show trends in data points 152 and events 175, scatter plots to illustrate relationships between variables, bar charts to compare the impacts of events 175, or heatmaps to highlight the intensity of relationships between multiple variables. The dashboard generator 146 can generate model performance metrics such as accuracy, precision, recall, F1-score, confusion matrices for classification accuracy, and receiver-operating characteristic (ROC) curves to assess the hybrid machine learning model's trade-offs between true positive and false positive rates. For event impact analysis, the dashboard generator 146 can generate an event timeline to visualize the sequence and effect of events on the target variable, event-specific analysis to gauge individual event impacts on predictions, and sensitivity analysis to evaluate model responsiveness to different event types. The client system 115, via the application interface 156, can present an interactive dashboard that allows users to explore data, filter results, and access detailed views. The dashboard generator 146 can generate automated alerts for potential compliance issues detected in real-time or near real-time. The dashboard generator 146 can implement APIs for integration with existing compliance software and reporting tools to facilitate a unified view of compliance metrics and forecasts.

The data processing system 105 can include, interface with, communicate with, or otherwise utilize an operation controller 148. The operation controller 148 can be or include any script, file, program, application, set of instructions, or computer-executable code that can be configured to manage and execute actions associated with one or more components of the data processing system 105, the client system 115, the machine learning system 120, the data source 125, or the payroll processing system 144. The operation controller 148 can define and manage workflows comprised of multiple interconnected tasks. The operation controller 148 can initiate, monitor, and control the execution of workflow steps. The operation controller 148 can implement conditional logic for dynamic workflow routing. The operation controller 148 can execute multiple tasks concurrently through parallel processing, where data preprocessing can occur at the source (e.g., client servers, data entry points) using distributed edge computing technologies. The operation controller 148 can implement error handling and recovery mechanisms for workflow exceptions. The operation controller 148 can track workflow progress and provide status updates. For example, the operation controller 148 can include one or more interfaces to detect input at various portions of a workflow and can provide output responsive to specific portions of a workflow.

The machine learning system 120 can include, interface with, communicate with, or otherwise utilize one or more hybrid machine learning models 160 trained on datasets. The machine learning system 120 can include a cloud system, a server, a distributed remote system, or any combination thereof. The machine learning system 120 can leverage parallel computing frameworks and graphics processing unit (GPU) acceleration for model training and inference, and can include, but is not limited to, at least, central processing unit (CPU), graphics processing unit (GPU), tensor processing units (TPUs), or the like. The machine learning system 120 can include a memory operable to store one or more instructions for operating components of the machine learning system 120 or operating components operably coupled to the machine learning system 120. The machine learning system 120 can be internal to the data processing system 105. The machine learning system 120 can exist external to the data processing system 105 and can be accessed via the network 110. The machine learning system 120 implements or otherwise provides access to one or more application programming interfaces (APIs), via which the data processing system 105 or the client system 115 can access the one or more hybrid machine learning models 160 or other functionality of the machine learning system 120.

The machine learning system 120 can include, interface with, communicate with, or otherwise utilize various hybrid machine learning models 160. The hybrid machine learning model 160 can be deployed within the data processing system 105 (as indicated by hybrid machine learning model 140) or externally as remote services. The hybrid machine learning model 140, residing within the data processing system 105, can be similar to, and include any of the structure and functionality of, the hybrid machine learning model 160. The hybrid machine learning model 160 can be trained with same or different types of machine learning techniques, trained with the same or different types of training data, or trained or configured to receive different types of input or provide different types of output. Example machine learning techniques can include neural networks, such as a generative adversarial network (e.g., a generator neural network and a discriminator neural network that are trained simultaneously through adversarial training), a variational autoencoder (e.g., an autoencoder neural network that learns to generate new data samples by modeling the underlying probability distribution of the data), an autoregressive model, or other types of neural networks (e.g., deep learning models, long short-term memory networks (LSTMs), temporal convolutional networks (TCNs), recurrent neural networks, or transformers), as well as attention layers to enhance relevant information in natural language processing. Transformers can refer to or include a type of deep learning model architecture configured for natural language processing, including, for example, bidirectional encoder representations (“BERT”), generative pre-trained transformers, text-to-text transformer, transformer-XL, robustly optimized BERT, or distilled BERT. Additional machine learning techniques can include tree-based models such as random forests and gradient boosting machines for structured data processing. Other types of machine learning techniques can include supervised learning models, unsupervised learning models, semi-supervised learning models, or reinforcement learning models. For example, a supervised machine learning technique can include a support vector machine used for classification and regression tasks. Given a set of labeled training data, a support vector machine can identify the hyperplane that separates the data into classes with the largest possible margin (e.g., distance between the hyperplane and nearest data points from each class).

The hybrid machine learning model 160 can combine multiple machine learning algorithms or techniques to leverage their strengths and address their limitations. The hybrid machine learning model 160 can integrate different types of models, such as combining supervised and unsupervised learning, or using models that operate on different types of data or tasks. The hybrid machine learning model 160 can employ ensemble models such as random forest and gradient boosting to improve accuracy for predictive analytics. The random forest can utilize bootstrap aggregation to address variance and reduce overfitting by generating multiple decision trees on data subsets. The gradient boosting can incrementally build decision trees to address errors, enhancing predictive precision in complex forecasting situations. The hybrid machine learning model 160 can process high-dimensional data, including structured datasets with features such as participant contribution behaviors, economic indicators, or event-driven changes (e.g., policy shifts, natural disasters, or market fluctuations). The hybrid machine learning model 160 can integrate diverse features without compromising predictive accuracy, with random forest's averaging mechanism or gradient boosting's iterative error-correction process managing noisy data and outliers to facilitate compliance-related predictions even in highly variable datasets. The hybrid machine learning model 160 can support scalability for real-time compliance testing by utilizing the ensemble approach to process high-volume and real-time datasets. The hybrid machine learning model 160 can process concurrent data processing for large volumes of records, thereby providing large-scale compliance forecasting.

The hybrid machine learning model 160 can implement weighted averaging with an adaptive weighting mechanism to dynamically adjust weights based on conditions or detected events. The hybrid machine learning model 160 can assign dynamic weights to each component in the ensemble to focus on the relevant data. For example, during periods of economic instability, the hybrid machine learning model 160 can increase the weight of models that focus on market indicators (e.g., stock market performance and interest rates) to improve compliance predictions. The hybrid machine learning model 160 can facilitate a stacked ensemble structure with a meta-learner, such as a neural network, that autonomously improves model combinations based on recent trends. The hybrid machine learning model 160 can determine which component, such as random forest or gradient boosting, performs better under specific conditions. The hybrid machine learning model 160 can integrate interpretability layers, such as Shapley values or LIME, to quantify the contribution of specific features to the model's output. These interpretability mechanisms can identify the impact of specific features on model outputs.

The hybrid machine learning model 160 can implement real-time or near real-time ensemble adaptation by updating, based on one or more events, one or more machine learning models or configurations within the hybrid machine learning model 160. The hybrid machine learning model 160 can implement online learning techniques (e.g., online gradient descent, incremental support vector machine algorithm) to dynamically adjust model weights and parameters in response to streaming events. The hybrid machine learning model 160 can utilize adaptive models to automatically tune parameters as new or updated compliance data or participant data arrives, thereby allowing the hybrid machine learning model 160 to respond to sudden changes, such as policy updates or economic shifts. By combining random forest and gradient boosting with adaptive weighting and stacked ensemble techniques, the hybrid machine learning model 160 can achieve high accuracy in compliance forecasting, improving forecast reliability by dynamically adapting to new or updated data.

The hybrid machine learning model 160 can generate personalized compliance predictions or a predicted data point associated with the profile data structure 150 for a specific time interval. The predicted data point, or personalized compliance prediction, can be generated by inputting the actual or historical data points 152 from a previous time interval, along with associated events 175 related to the profile data structure 150, into the hybrid machine learning model 160, which may be reconfigured to optimize processing for the prediction task. The hybrid machine learning model 160 can output a predicted data point, such as a future contribution value or risk assessment.

The predicted data point, or personalized compliance prediction, can be based on long-term dependencies or local temporal patterns in actual or historical data points 152 from a previous time interval, along with associated events 175 related to the profile data structure 150. The hybrid machine learning model 160 can implement individual-level predictive modeling using LSTM networks with participant embeddings to capture participant-specific contribution behaviors over time and model the impact of past events, such as economic downturns or environmental conditions, on future contributions. The hybrid machine learning model 160 can combine the outputs of multiple algorithms, including LSTM, random forest, and gradient boosting, to improve prediction accuracy. The hybrid neural network architecture can integrate LSTM units for long-term dependencies, TCNs for local temporal patterns and short-term trends, and attention layers for focusing on relevant portions or predictive aspects of the input sequence, such as recent events or changes in economic indicators, can be incorporated as additional input features to improve precision across varying temporal patterns. Additionally, the hybrid machine learning model 160 can be deployed on a distributed or parallel computing framework to process large-scale datasets and provide real-time or near real-time predictions.

The machine learning system 120 can include, interface with, communicate with, or otherwise utilize a model manager 162. The model manager 162 can train, fine-tune, update, re-train, adjust, or otherwise maintain one or more hybrid machine learning models 160. The model manager 162 can include hardware, software, or any combination thereof. The model manager 162 can reside within the data processing system 105, where the model manager 162 can manage and coordinate the training, fine-tuning, and updating of the hybrid machine learning model 160. In some embodiments, the model manager 162 can exist outside the data processing system 105, operating as a remote service that interacts with the data processing system 105 via APIs. The model manager 162 can facilitate the training of hybrid machine learning model 160 on training datasets 154 and can fine-tune the hybrid machine learning models 160 for specific tasks or domains. The model manager 162 can manage the deployment of hybrid machine learning model 160 in production environments and the integration of hybrid machine learning model 160 with other systems and services.

The model manager 162 can continuously monitor the performance of deployed hybrid machine learning model 160, identify issues, and update hybrid machine learning model 160. The model manager 162 can use various machine learning algorithms, including supervised learning techniques, to train, fine-tune, or update one or more hybrid machine-learning models 160 using labeled data or training dataset 154 to improve the prediction accuracy of the hybrid machine learning model 160. The model manager 162 can utilize advanced techniques such as deep feature synthesis (DFS) to automatically generate new features from the existing data. The DFS can combine multiple features to create more complex and informative features to improve the performance of the hybrid machine learning model 160. The model manager 162 can implement unsupervised learning techniques, such as clustering and association rule mining, to identify patterns in unlabeled data, or to generate labels for said unlabeled data. The model manager 162 can implement reinforcement learning techniques to update the hybrid machine learning model 160 based on user-provided feedback or training dataset 154.

The model manager 162 can train the hybrid machine learning model 160 on a large training dataset 154 that includes examples of events 175 and corresponding data points 152 associated with a profile data structure 150. Each data point 152 can be labeled or annotated to specify its relationship to particular events 175, such as economic indicators, regulatory changes, or geopolitical events, and the profile data structure 150 it impacts. These data points can correspond to various attributes of individuals or entities, including income, age, location, or historical contribution data. The events 175 can include economic indicators, regulatory changes, or geopolitical events. Each data point 152 can be labeled to indicate event associations (e.g., associating a decrease in contribution values with an economic recession), profile data structure associations, and time-series information with timestamps to detect temporal patterns. During training, the hybrid machine learning model 160 can undergo feature engineering to extract relevant time-series, categorical, or numerical features. The model manager 162 can perform model selection to identify suitable algorithms, such as LSTM networks, TCNs, random forests, or gradient boosting, based on the data characteristics or prediction task. The training process can include refining model parameters to minimize prediction errors. The model manager 162 can evaluate the hybrid machine learning model 160 on a validation dataset to determine its accuracy and generalization ability. The hybrid machine learning model 160 can be further refined using techniques such as hyperparameter tuning, regularization, or additional feature engineering to improve predictive performance.

The model manager 162 can balance the training dataset 154 by maintaining a representative number of examples for each event category to prevent model bias. After training, the model manager 162 can evaluate the performance of the hybrid machine learning model 160 using a separate validation dataset to confirm that the model can accurately predict data points for a specific time interval based on detected events and historical data points. The model manager 162 can train the hybrid machine learning model 160 to predict future data points that may impact contribution values associated with a profile data structure 150 for a future time interval. The model manager 162 can further refine the model's capability to detect specific patterns, such as those related to contribution trends or market shifts, based on the operational requirements of the compliance forecasting system.

The model manager 162 can update or reconfigure one or more machine learning models of the hybrid machine learning model 160. The reconfiguration can refer to the process of modifying the structure or parameters of the hybrid machine learning model 160 or one or more machine learning models of the hybrid machine learning model 160 to improve the model's performance in response to specific events. For example, the reconfiguration can include adjusting model weights, adding or removing layers, or modifying the input features to better capture the nuances of the event and its impact on the future contribution values. The update can include adjustments to at least one machine learning model of the hybrid machine learning model 160.

The model manager 162 can update one or more machine learning models of the hybrid machine learning model 160 based on the relevance of each model to the detected event 175, categorized by type (e.g., economic, regulatory, or environmental). The model manager 162 can evaluate the detected event to determine its potential impact on the target variable based on factors such as the severity, frequency, or historical impact of the event. Based on the characteristics of the event 175, the model manager 162 can select the appropriate machine learning model(s) for updating. For example, if the event is an economic shock, the model manager 162 can prioritize models that are sensitive to macroeconomic factors, such as LSTM or TCN. The model manager 162 can prepare the relevant data, such as data points or events, for training or fine-tuning of the selected models. The model manager 162 can implement data cleaning, feature engineering, feature selection algorithms (e.g., recursive feature elimination (RFE) to select the most impactful features), or normalization to maintain quality and consistency. For model training or fine-tuning, the model manager 162 can initiate retraining if the event modifies the underlying data distribution, or apply fine-tuning techniques, such as gradient descent, for minor adjustments. The updated model can then be evaluated on a validation dataset, using metrics like accuracy, precision, recall, and F1-score to evaluate performance. If the updated model satisfies the performance standards, the model manager 162 can deploy it to the production environment for real-time predictions.

The model manager 162 can update the weights of one or more machine learning models of the hybrid machine learning model 160 based on the detected events 175. The model manager 162 can dynamically adjust model weights within the ensemble according to the event's characteristics. The model manager 162 can evaluate the detected event 175 to determine its impact or relevance to an entity. Based on the evaluation, the model manager 162 can adjust the weights assigned to different models in the ensemble. For example, the model manager 162 can increase the weights of models more relevant to the event while reducing those less relevant. For instance, in response to an economic event, the model manager 162 can increase the weights of models sensitive to economic indicators. In some embodiments, the model manager 162 can initiate retraining of the entire model or specific components. The model manager 162 can incorporate new or updated data into the training set or adjust hyperparameters to better indicate the impact of the event.

The model manager 162 can adjust the hyperparameters of one or more machine learning models of the hybrid machine learning model 160 based on detected events 175. The model manager 162 can modify hyperparameters such as the number of layers, neurons, or regularization parameters based on the severity or impact of the detected event 175. The model manager 162 can dynamically adjust the learning rate, which determines the step size during optimization. The model manager 162 can apply a higher learning rate for rapid convergence or a lower rate for fine-tuning. The model manager 162 can modify regularization parameters, such as L1 and L2 regularization, to prevent overfitting based on data complexity or noise levels. The model manager 162 can implement Bayesian optimization to explore the hyperparameter space and identify the settings for the given event 175 and data conditions.

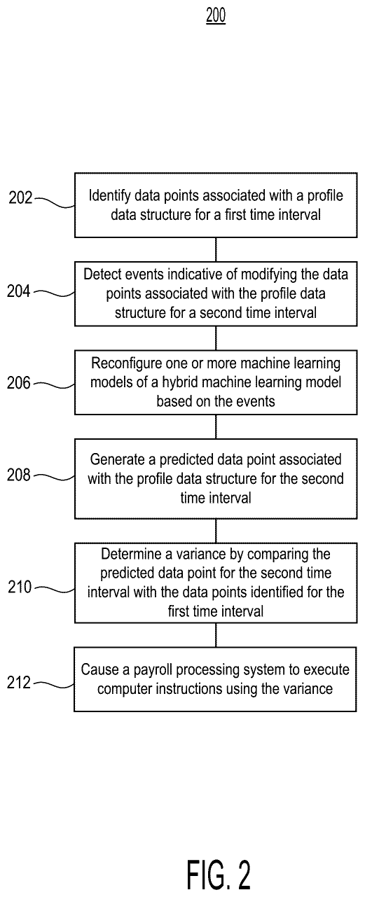

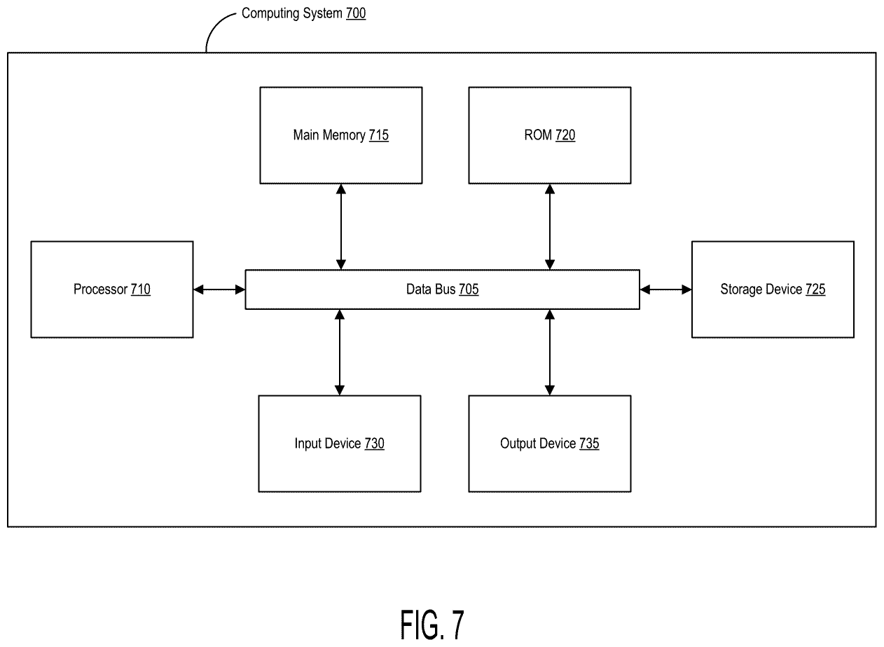

FIG. 2 depicts a method 200 of network operation execution based on event detection and predictive analytics using a hybrid machine learning model. The method 200 can be implemented using a system 100, 700, or any other features discussed in FIG. 1 or FIG. 7. The method can include Acts 202-212. The Acts 202-212 can be executed in any order or sequence.

At 202, the method 200 can identify data points associated with a profile data structure for a first time interval. In an aspect, the method can include identifying, from a database, data points associated with the profile data structure for the first time interval.

At 204, the method 200 can detect events indicative of modifying the data points associated with the profile data structure for a second time interval. In an aspect, the method can include detecting the events from a data source. In an aspect, the method can include detecting the events from the data source based on patterns indicative of causing changes to the data points associated with the profile data structure. In an aspect, the method can include extracting the events as input data for the hybrid machine learning model.

At 206, the method 200 can reconfigure one or more machine learning models of a hybrid machine learning model based on the events. The hybrid machine learning model can include at least one of a long short-term memory network, a temporal convolutional network, an attention layer, a random forest, or a gradient boosting machine. The one or more machine learning models can be trained based on a training dataset including a plurality of events and corresponding data points. In an aspect, the method can include reconfiguring the one or more machine learning models of the hybrid machine learning model based on a relevance of the one or more machine learning models to the events. In another aspect, the method can include reconfiguring weights of the one or more machine learning models of the hybrid machine learning model based on the events. In another aspect, the method can include adjusting hyperparameters of the one or more machine learning models based on the events.

At 208, the method 200 can generate a predicted data point associated with the profile data structure for the second time interval. In an aspect, the method can include generating the predicted data point associated with the profile data structure for the second time interval using the data points and the one or more events as input into the hybrid machine learning model that is reconfigured. The hybrid machine learning model can generate the predicted data point based on determining long-term dependencies and local temporal patterns in the data points and the events associated with the profile data structure for the second time interval. In an aspect, the method can include selecting, based on the one or more events, the one or more machine learning models of the hybrid machine learning model to receive input data, including the data points and the events. In an aspect, the method can include aggregating predicted data points of each selected machine learning model to generate the predicted data point for the second time interval.

At 210, the method 200 can determine a variance by comparing the predicted data point for the second time interval with the data points identified for the first time interval. The comparison can include calculating the difference between the predicted and historical or actual contribution values to evaluate changes over time. The variance can indicate the level of impact that events can have on the data points associated with the profile data structure for a specific time interval.

At 212, the method 200 can cause a payroll processing system to execute computer instructions using the variance. In an aspect, the method can include causing the payroll processing system to execute one or more computer instructions by transmitting the variance to the payroll processing system. The payroll processing system can use the variance to execute the one or more computer instructions. In an aspect, the method can include causing the payroll processing system to execute the one or more computer instructions in response to determining that the variance satisfies a threshold. In another aspect, the method can include causing the payroll processing system to block the one or more computer instructions in response to determining that the variance exceeds a threshold.

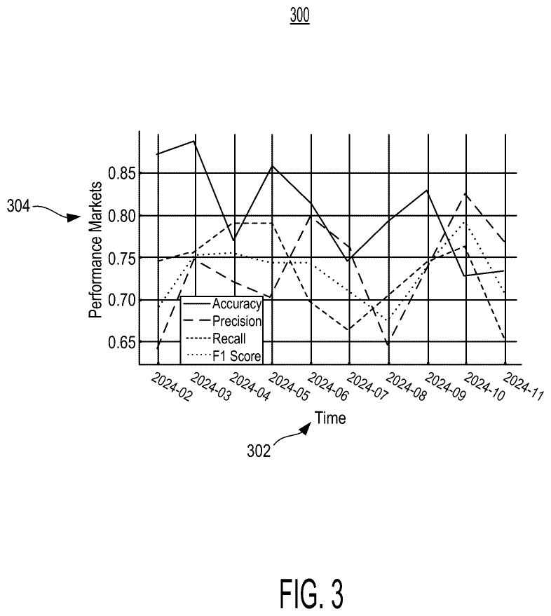

FIG. 3 depicts an example line chart 300 illustrating model performance over time, according to one or more aspects of the technical solutions described herein. As illustrated by way of example in FIG. 3, the line chart 300 shows trends for accuracy, precision, recall, and F1 score, providing a view of hybrid machine learning model performance over time. The x-axis 302 indicates the time period during which the hybrid machine learning model's performance is evaluated. The time period can span monthly intervals from February 2024 to November 2024. The y-axis 304 displays the values of performance metrics, including accuracy, precision, recall, and F1 score. The accuracy can indicate the proportion of correct predictions out of the total predictions to indicate the hybrid machine learning model's overall correctness. The precision can measure the proportion of true positive predictions out of all positive predictions, indicating the hybrid machine learning model's accuracy in identifying true positive cases. The recall can evaluate the hybrid machine learning model's ability to identify all positive cases, indicated by the proportion of true positive predictions out of all actual positive cases. The F1 score can provide a balanced measure of performance by calculating the mean of precision and recall. The line chart 300 illustrates fluctuations in the performance metrics over time, with accuracy and precision generally trending upward, indicating improved prediction correctness and true positive identification. Recall shows more variability, indicating fluctuations in the hybrid machine learning model's ability to identify all positive cases, and the F1 score shows an overall upward trend, indicating balanced improvements in both precision and recall.

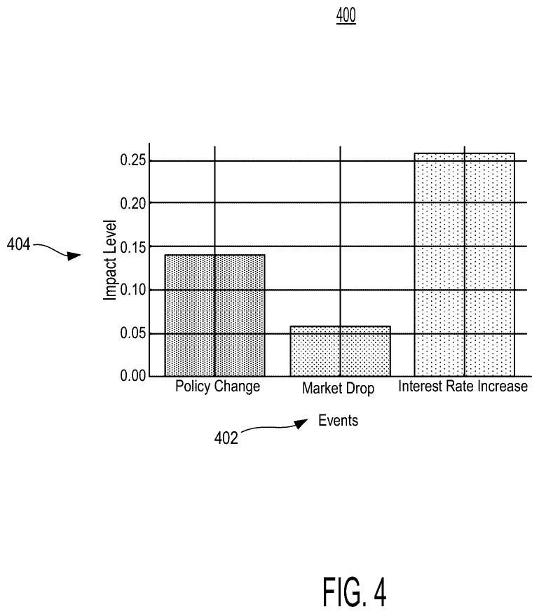

FIG. 4 depicts an example bar chart 400 illustrating the impact of events on predictions, according to one or more aspects of the technical solutions described herein. As illustrated by way of example in FIG. 4, the bar chart 400 shows the impact of recent events, such as a policy change, market drop, or interest rate increase, on prediction adjustments. The x-axis 402 indicates different types of events that can affect the hybrid machine learning model's predictions. The events include policy change, indicating shifts in government regulations, industry standards, or company policies; market drop, indicating a decline in the stock market or broader economic downturn; and interest rate increase, indicating an increase in interest rates set by a financial authority. The y-axis 404 corresponding to impact level quantifies the degree to which each event influences the hybrid machine learning model's predictions, with higher levels indicating a greater effect on the hybrid machine learning model's output. The bar chat 400 indicates that the interest rate increase has the highest impact level, suggesting that the interest rate increase exerts a substantial influence on the hybrid machine learning model's predictions. The policy change has a moderate impact level, indicating that policy adjustments can meaningfully affect hybrid machine learning model outputs. The market drop has the lowest impact level among the three events, indicating that while market fluctuations do influence the hybrid machine learning model's predictions, their effect is relatively less significant compared to policy changes and interest rate increases.

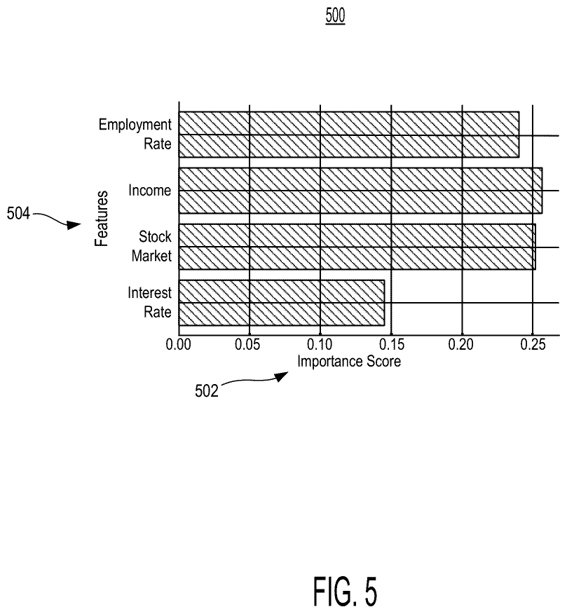

FIG. 5 depicts an example horizontal bar chart 500 illustrating feature importance, according to one or more aspects of the technical solutions described herein. As illustrated by way of example in FIG. 5, the horizontal bar chart 500 ranks feature importance, indicating which economic indicators have the most significant impact on forecasts. The x-axis 502 indicates the importance score, ranging from 0 to 0.25, where a higher score indicates a greater impact of the feature on the hybrid machine learning model's predictions. The y-axis 504 lists various features evaluated by the hybrid machine learning model. The features 504 can include employment rate, measuring employment levels within the economy; income, indicating income levels, which impact consumer spending and economic activity; stock market, indicating stock market performance and its influence on investor sentiment and economic growth; and interest rate, indicating borrowing costs, which impact economic activity and consumer spending. The horizontal bar chart 500 shows that the length of each bar corresponds to the importance score of the respective feature. For example, income and stock market have the highest importance scores, indicating a significant impact on the hybrid machine learning model's predictions. The employment rate indicates a moderately high importance score, indicating that the employment rate also plays an important role in predictions. The interest rate has the lowest importance score among the four features, indicating a relatively smaller influence on the hybrid machine learning model's output.

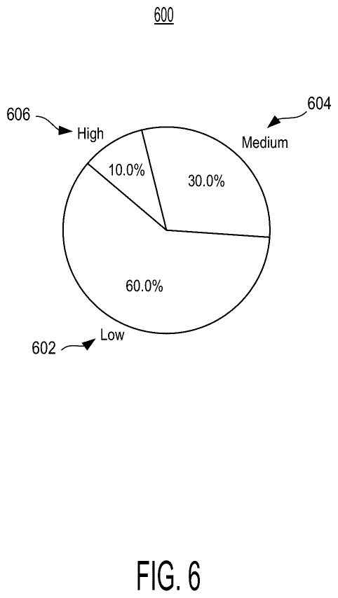

FIG. 6 depicts an example pie chart 600 illustrating a risk level distribution, according to one or more aspects of the technical solutions described herein. As illustrated by way of example in FIG. 6, the pie chart 600 provides a current distribution of participants across low risk level 602, medium risk level 604, and high compliance risk level 606. The low risk level 602 can include participants with a low likelihood of non-compliance who are generally less impacted by detected events. The medium risk level 604 can include participants who exhibit moderate compliance risk, with occasional lapses or the need for additional monitoring to maintain full compliance. Detected events, such as policy changes, market fluctuations, or natural disasters, can impact these participants more significantly. The high risk level 606 can include participants at a high risk of non-compliance, often with a history of violations, regulatory non-adherence, or other factors indicating a greater probability of future compliance issues. For these participants, detected events can exacerbate or intensify compliance challenges, leading to a higher likelihood of non-compliance. The pie chart 600 can provide a visual distribution of participants within each risk category, with a larger slice indicating a higher proportion of participants in that category. For example, if the low risk segment is the largest, this indicates that a significant portion of participants are deemed low risk.

FIG. 7 depicts a block diagram of a computing system 700 for implementing the embodiments of the technical solutions discussed herein, in accordance with various aspects. FIG. 7 illustrates a block diagram of an example computing system 700, which can also be referred to as the computer system 700. Computing system 700 can be used to implement elements of the systems and methods described and illustrated herein. Computing system 700 can be included in and run any device (e.g., a server, a computer, a cloud computing environment or a data processing system).

Computing system 700 can include at least one bus data bus 705 or other communication device, structure or component for communicating information or data. Computing system 700 can include at least one processor 710 or processing circuit coupled to the data bus 705 for executing instructions or processing data or information. Computing system 700 can include one or more processors 710 or processing circuits coupled to the data bus 705 for exchanging or processing data or information along with other computing systems 700. Computing system 700 can include one or more main memories 715, such as a random access memory (RAM), dynamic RAM (DRAM), cache memory or other dynamic storage device, which can be coupled to the data bus 705 for storing information, data and instructions to be executed by the processor(s) 710. Main memory 715 can be used for storing information (e.g., data, computer code, commands or instructions) during execution of instructions by the processor(s) 710.

Computing system 700 can include one or more read only memories (ROMs) 720 or other static storage device 725 coupled to the bus 705 for storing static information and instructions for the processor(s) 710. Storage devices 725 can include any storage device, such as a solid-state device, magnetic disk or optical disk, which can be coupled to the data bus 705 to persistently store information and instructions.

Computing system 700 can be coupled via the data bus 705 to one or more output devices 735, such as speakers or displays (e.g., liquid crystal display or active matrix display) for displaying or providing information to a user. Input devices 730, such as keyboards, touch screens or voice interfaces, can be coupled to the data bus 705 for communicating information and commands to the processor(s) 710. Input device 730 can include, for example, a touch screen display (e.g., output device 735). Input device 730 can include a cursor control, such as a mouse, a trackball, or cursor direction keys, for communicating direction information and command selections to the processor(s) 710 for controlling cursor movement on a display.

The processes, systems and methods described herein can be implemented by the computing system 700 in response to the processor 710 executing an arrangement of instructions contained in main memory 715. Such instructions can be read into main memory 715 from another computer-readable medium, such as the storage device 725. Execution of the arrangement of instructions contained in main memory 715 causes the computing system 700 to perform the illustrative processes described herein. One or more processors 710 in a multi-processing arrangement can also be employed to execute the instructions contained in main memory 715. Hard-wired circuitry can be used in place of or in combination with software instructions together with the systems and methods described herein. Systems and methods described herein are not limited to any specific combination of hardware circuitry and software.

Although an example computing system has been described in FIG. 7, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
identify, from a database, data points associated with a profile data structure for a first time interval;
detect, from a data source, one or more events indicative of modifying the data points associated with the profile data structure for a second time interval;
update, based on the one or more events, a hybrid machine learning model that comprises a plurality of machine learning models, the update comprising an adjustment of at least one of the plurality of machine learning models;
generate a predicted data point associated with the profile data structure for the second time interval based on the data points and the one or more events being input into the hybrid machine learning model;
determine a variance in response to comparing the predicted data point for the second time interval to the data points identified for the first time interval; and
transmit the variance to a payroll processing system to cause the payroll processing system to execute, for the second time interval, a network operation associated with the profile data structure based on the variance.

2. The system of claim 1, wherein the one or more processors are further configured to:
detect the one or more events from the data source based on patterns indicative of causing changes to the data points associated with the profile data structure; and
extract the one or more events as input data for the hybrid machine learning model.

3. The system of claim 1, wherein the hybrid machine learning model comprises at least one of a long short-term memory network, a temporal convolutional network, an attention layer, a random forest, or a gradient boosting machine.

4. The system of claim 1, wherein the one or more processors are further configured to update the at least one of the plurality of machine learning models of the hybrid machine learning model based on a relevance of the at least one of the plurality of machine learning models to the one or more events.

5. The system of claim 1, wherein the one or more processors are further configured to update weights of the at least one of the plurality of machine learning models of the hybrid machine learning model based on the one or more events.

6. The system of claim 1, wherein the one or more processors are further configured to adjust hyperparameters of the at least one of the plurality of machine learning models based on the one or more events.

7. The system of claim 1, wherein the one or more processors are further configured to:
select, based on the one or more events, the at least one of the plurality of machine learning models of the hybrid machine learning model to receive input data comprising the data points and the one or more events; and
aggregate predicted data points of each selected machine learning model to generate the predicted data point for the second time interval.

8. The system of claim 1, wherein the one or more processors are further configured to cause the payroll processing system to execute the network operation in response to determining that the variance satisfies a threshold.

9. The system of claim 1, wherein the one or more processors are further configured to cause the payroll processing system to block the network operation in response to determining that the variance exceeds a threshold.

10. The system of claim 1, wherein the one or more processors are further configured to train the at least one of the plurality of machine learning models based on a training dataset comprising a plurality of events and corresponding data points.

11. The system of claim 1, wherein the hybrid machine learning model generates the predicted data point based on determining long-term dependencies and local temporal patterns in the data points and the one or more events associated with the profile data structure for the second time interval.

12. A method, comprising:
identifying, from a database, data points associated with a profile data structure for a first time interval;
detecting, from a data source, one or more events indicative of modifying the data points associated with the profile data structure for a second time interval;
reconfiguring, based on the one or more events, one or more machine learning models of a hybrid machine learning model;
generating a predicted data point associated with the profile data structure for the second time interval using the data points and the one or more events as input into the hybrid machine learning model that is reconfigured;
determining a variance in response to comparing the predicted data point for the second time interval to the data points identified for the first time interval; and
causing a payroll processing system to execute one or more computer instructions by transmitting the variance to the payroll processing system, the payroll processing system using the variance to execute the one or more computer instructions.

13. The method of claim 12, further comprising:
detecting the one or more events from the data source based on patterns indicative of causing changes to the data points associated with the profile data structure; and
extracting the one or more events for input into the hybrid machine learning model.

14. The method of claim 12, wherein the hybrid machine learning model comprises at least one of a long short-term memory network, a temporal convolutional network, an attention layer, a random forest, or a gradient boosting machine.

15. The method of claim 12, further comprising:
reconfiguring the one or more machine learning models of the hybrid machine learning model based on a relevance of the one or more machine learning models to the one or more events.

16. The method of claim 12, further comprising:
reconfiguring weights of the one or more machine learning models of the hybrid machine learning model based on the one or more events.

17. The method of claim 12, further comprising:
adjusting hyperparameters of the one or more machine learning models based on the one or more events.

18. The method of claim 12, further comprising:
selecting, based on the one or more events, the one or more machine learning models of the hybrid machine learning model to receive input data comprising the data points and the one or more events; and
aggregating predicted data points of each selected machine learning model to generate the predicted data point for the second time interval.

19. The method of claim 12, further comprising:
causing the payroll processing system to execute the one or more computer instructions in response to determining that the variance satisfies a threshold.

20. A non-transitory computer readable medium including one or more instructions stored thereon and executable by a processor to:
identify, from a database, data points associated with a profile data structure for a first time interval;
detect, from a data source, one or more events indicative of modifying the data points associated with the profile data structure for a second time interval;
adjust, based on the one or more events, a hybrid machine learning model by adjusting parameters of one or more machine learning models of the hybrid machine learning model;
generate, using the hybrid machine learning model that is adjusted, a predicted data point associated with the profile data structure for the second time interval;
determine a variance between the predicted data point for the second time interval and the data points identified for the first time interval; and
present, via a graphical user interface, the data points, the one or more events, and the variance.
